(19) United States
(12) Patent Application Publication
(10) Pub. No.: US 2026/0308382 A1
(43) Pub. Date: Oct. 8, 2026

(54) DECORATIVE PANEL AND METHOD TO MAKE SUCH DECORATIVE PANEL

(71) Applicant: UNILIN, BV, Wielsbeke (BE)

(72) Inventors: Margot FONTEYN, Wielsbeke (BE); Benjamin CLEMENT, Wielsbeke (BE)

(21) Appl. No.: 19/482,395

(22) PCT Filed: Apr. 29, 2024
(86) PCT No.: PCT/IB2024/054141

§ 371 Date: Nov. 7, 2025

Related U.S. Application Data
(60) Provisional application No. 63/502,423, filed on May 16, 2023.

(51) Int. Cl. C08L 97/02; E04F 15/02; E04F 15/10

(52) U.S. Cl. CPC C08L 97/02; E04F 15/02038; E04F 15/107; E04F 2201/0153; E04F 2201/023; E04F 2201/042; E04F 2201/043

(57) ABSTRACT

A method for producing a decorative panel includes the steps of providing a first set of lignocellulosic particles having a first color; and providing a second set of lignocellulosic particles having a second color; wherein the first color differs from the second color. The method includes the steps of scattering or depositing the first set of lignocellulosic particles, scattering or depositing the second set of lignocellulosic particles; and consolidating the first set of lignocellulosic particles and the second set of lignocellulosic particles using a binder thereby obtaining a decorative particulate layer of at least 0.5 mm thick.

The invention relates to decorative panels comprising lignocellulosic particles.

A number of types of panels based on lignocellulosic particles exist, e.g. wood fiberboard based panels and wood particle board based panels. It is known to apply a décor layer, e.g. comprising a resin impregnated printed paper décor layer onto the panel.

It is a disadvantage of such panels that when the appearance of the panels has deteriorated because of wear of the panels, there is no possibility of restoration the visual aspect of the decorative panels.

Therefore, it is an object of the invention to provide a method for producing decorative panels of which the decorative aspect can be restored after wear of the panels. It is an object of the invention to provide panels the decorative aspect of which can be restored after wear of the panels.

It is an object of embodiments of the invention to provide decorative panels the manufacturing of which has less environmental impact and/or uses biobased materials to a larger extent.

The first aspect of the invention is a method for producing a decorative panel. The method comprises the steps of
providing a first set of lignocellulosic particles, wherein the lignocellulosic particles of the first set of lignocellulosic particles have a first color;
providing a second set of lignocellulosic particles, wherein the lignocellulosic particles of the second set of lignocellulosic particles have a second color; wherein the first color differs from the second color;
scattering or depositing the first set of lignocellulosic particles; and scattering or depositing the second set of lignocellulosic particles;
consolidating the first set of lignocellulosic particles and the second set of lignocellulosic particles using a binder thereby obtaining a decorative particulate layer of at least 0.5 mm thick, preferably of at least 1 mm thick, and more preferably of at least 3 mm thick.

The method of the invention allows to produce a decorative panel having a decorative particulate layer. The decorative surface can be sanded after signs of wear are visible at the surface of the decorative panel. It is a benefit that after sanding, the panel still has a decorative surface.

It is possible that a lacquer layer is applied onto the decorative panel for increasing the wear resistance of the panel. After sanding after signs of wear of the decorative panel, a new lacquer layer can be applied to increase the wear resistance of the decorative panel.

A lacquer can be applied on at least part of the side edges of the decorative panel. Such embodiments provide a decorative panel having improved durability.

A lacquer can be applied on the full surface of the bottom of the decorative panel. Such embodiments provide a decorative panel having improved durability.

The lignocellulosic particles of the first set of lignocellulosic particles can preferably be fibers, chips, shives or flour (e.g. wood flour). It is a benefit that such particles are biobased.

The lignocellulosic particles of the second set of lignocellulosic particles can preferably be fibers, chips, shives or flour (e.g. wood flour). It is a benefit that such particles are biobased.

Examples of lignocellulosic particles that can be used for the lignocellulosic particles of the first set or for the lignocellulosic particles of the second set are wood chips, plant shives (e.g. flax shives, miscanthus shives), wood fiber or other vegetal fiber and wood flour. Such particles are biobased. Wood fibers, wood chips and wood flour can even be based on waste products and/or end-of-life wood products.

Preferably, the decorative particulate layer is less than 12 mm thick, more preferably less than 10 mm thick.

Alternative depositing techniques than scattering can be used to deposit the first set of lignocellulosic particles or the second set of lignocellulosic particles or both. An alternative depositing technique that can be used is casting, e.g. in which a binder—e.g. a thermoset binder or a thermoplastic binder—is added to the first set of lignocellulosic particles or to the second set of lignocellulosic particles or to both, thereby obtaining a paste or slurry, which can be casted. In casting color patterns can be formed in the same way as in a scattering operation. It is also possible that the lignocellulosic particles of the first set and the lignocellulosic particles of the second set are inhomogeneously blended in the paste.

A preferred method is characterized in that the binder comprises or consists of a thermoset binder or a thermoplastic binder, or a combination of a thermoset binder and a thermoplastic binder.

A preferred method is characterized in that the binder comprises a thermoset binder, wherein the thermoset binder is selected from the list of a urea formaldehyde binder, a melamine urea formaldehyde binder, a polyurethane binder, a polymeric methylene diphenyl diisocyanate (pMDI) binder, a hyperbranched polyamide, a starch based resin, a thermoset polyester, or a biobased thermoset resin. The preferred method comprises the step of curing the thermoset binder.

Use in the method of hyperbranched polyamides, starch based resins, or biobased thermoset resins has the benefit that they are biobased, increasing the amount of biobased raw materials used in manufacturing the decorative panel.

A preferred method is characterized in that the binder comprises a thermoplastic binder, wherein the thermoplastic binder is selected from the list of thermoplastic polyurethane (TPU), polylactic acid (PLA), polyvinyl butyral (PVB), polyhydroxyalkanoates (PHA), polyvinyl acetate (PVAc), thermoplastic acrylates, or acrylonitrile/butadiene/styrene copolymers.

Use in the method of polylactic acid (PLA) or polyhydroxyalkanoates (PHA) is particularly preferred, as the amount of biobased materials used is increased.

A preferred method is characterized in that the binder comprises pigments or dyes.

A binder comprising pigments or dyes has the benefit that the lignocellulosic particles of the first set of lignocellulosic particles can be provided with the first color, or the lignocellulosic particles of the second set of lignocellulosic particles can be provided with the second color, or a coloration in the mass of the decorative particulate layer can be obtained, around both sets of lignocellulosic particles.

It is e.g. possible that the lignocellulosic particles of the first set of lignocellulosic particles are coated with a binder comprising pigments or dyes before scattering the first set of lignocellulosic particles, thereby providing the lignocellulosic particles of the first set of lignocellulosic particles with their first color.

It is e.g. possible that the lignocellulosic particles of the second set of lignocellulosic particles are coated with a binder comprising pigments or dyes before scattering the second set of lignocellulosic particles, thereby providing the lignocellulosic particles of the second set of lignocellulosic particles with their second color.

A preferred method is characterized in that a lacquer (e.g. a varnish or a stain) is applied onto the decorative particulate layer. The application of such lacquer improves the wear resistance of the decorative panel.

Such panel has the benefit that after wear has occurred, the surface of the panel can be sanded thereby restoring the visual appearance of the original panel, and a new lacquer layer, e.g. a varnish or stain, can be applied.

The lacquer can be a transparent lacquer.

The lacquer can be a colored lacquer, e.g. a lacquer comprising pearlescent particles.

The lacquer can be a polyurethane lacquer. The lacquer can be an acrylate lacquer. The lacquer can be a radiation curable lacquer, e.g. a UV-curing lacquer, an excimer curing lacquer or an electron beam curing lacquer.

The lacquer can also be a lacquer that cures at room temperature.

A preferred method is characterized in that the method comprises the step of applying a resin impregnated paper sheet on the decorative particulate layer provided by the combination of the first set of lignocellulosic particles and the second set of lignocellulosic particles. More preferably, the resin impregnated paper sheet is provided for forming a transparent wear layer on the decorative panel. Such embodiments provide a decorative panel with improved wear resistance, e.g. for use in floor coverings.

The resin can optionally comprise wear resistant particles, such as corundum particles.

The resin with which the paper is impregnated can preferably be a melamine based resin, an acrylate resin, a polyurethane resin or a thermoset polyester resin.

The lignocellulosic particles of the first set of lignocellulosic particles can be dyed to obtain the first color, preferably using biobased dyes or biobased pigments.

The use of biobased dyes or biobased pigments is preferred, as it increases the amount of biobased materials used in manufacturing the decorative panel.

The lignocellulosic particles of the second set of lignocellulosic particles can be dyed to obtain the second color, preferably using biobased dyes or biobased pigments.

The use of biobased dyes or biobased pigments is preferred, as it increases the amount of biobased materials used in manufacturing the decorative panel.

In an embodiment of the invention, the second color is the natural color of the lignocellulosic particles of the second set of lignocellulosic particles. It is a benefit of this embodiment that less raw material is required and the manufacturing of the decorative panel needs less processing steps as the lignocellulosic particles of the second set do not need to be dyed or colored. Consequently, the manufacturing of the decorative panel has less environmental impact.

An embodiments of the method according to the invention is characterized in that the first color is the natural color of the lignocellulosic particles of the first set of lignocellulosic particles; and that the second color is the natural color of the lignocellulosic particles of the second set of lignocellulosic particles.

It is a benefit of this embodiment that less raw material is required and the manufacturing of the decorative panel needs less processing steps as the lignocellulosic particles of the first set nor the lignocellulosic particles of the second set need to be dyed or colored. Consequently, the manufacturing of the decorative panel has less environmental impact.

In such embodiments, the first color and the second color can differ because of differences in raw materials used, e.g. the first set of lignocellulosic particles can consists of flax shives and the second set of lignocellulosic particles can consist of miscanthus shives or miscanthus chips.

A preferred method is characterized in that the first set of lignocellulosic particles is coated with an uncured thermoset binder before being scattered, optionally wherein the uncured thermoset binder comprises pigments or dyes.

In embodiments wherein the uncured thermoset binder comprises pigments or dyes, the lignocellulosic particles of the first set obtain the first color via the pigments or dyes in the uncured thermoset binder. Such embodiments reduce the number of processing steps that are required, reducing the environmental impact of the manufacturing of the decorative panel.

More preferably, the thermoset binder with which the first set of lignocellulosic particles is coated is selected from a urea formaldehyde binder, a melamine urea formaldehyde binder, a polyurethane binder, a pMDI binder, a hyperbranched polyamide, a starch based resin, a thermoset polyester resin, or a biobased thermoset resin. The use of a hyperbranched polyamide, starch based resin or biobased thermoset resin is particularly preferred, as the amount of biobased materials used in manufacturing the decorative panel is increased.

A preferred method is characterized in that the second set of lignocellulosic particles is coated with an uncured thermoset binder before being scattered, optionally wherein the uncured thermoset binder comprises pigments or dyes.

In embodiments wherein the uncured thermoset binder with which the second set of lignocellulosic particles is coated comprises pigments or dyes, the lignocellulosic particles of the second set obtain the second color via the pigments or dyes in the uncured thermoset binder. Such embodiments reduce the number of processing steps that are required, reducing the environmental impact of the manufacturing of the decorative panel.

More preferably, the thermoset binder with which the second set of lignocellulosic particles is coated is selected from a urea formaldehyde binder, a melamine urea formaldehyde binder, a polyurethane binder, a pMDI binder, a hyperbranched polyamide, a starch based resin, a thermoset polyester resin, or a biobased thermoset resin. The use of hyperbranched polyamide, starch based resin, or biobased thermoset resin is particularly preferred, as the amount of biobased materials used in manufacturing the decorative panel is increased.

A preferred method is characterized in that the first set of lignocellulosic particles is scattered by a first scattering device; and that the second set of lignocellulosic particles is scattered by a second scattering device, such that patterns of lignocellulosic particles having the first color and patterns of lignocellulosic particles having the second color are obtained in the decorative particulate layer.

Such embodiments provide a simple ways of establishing a decorative pattern in the decorative particulate layer.

The scattering by the first scattering device—and preferably also the scattering by the second scattering device—can preferably be controlled by a control unit thereby obtaining predetermined scattering patterns.

A preferred method according to the invention is characterized in that the first set of lignocellulosic particles and the second set of lignocellulosic particles are blended—preferably inhomogeneously—before being scattered or deposited together.

Such embodiments require less complex equipment for scattering or depositing the first set and the second set of lignocellulosic particles, while a decorative particulate layer can be easily obtained.

A preferred method is characterized in that during or after the step of consolidating the first set of lignocellulosic particles and the second set of lignocellulosic particles, a surface texture is pressed into the decorative particulate layer. Such embodiments provide a more pronounced decorative surface effect, thanks to the surface texture provided.

Before or after pressing the surface texture, preferably a lacquer is applied onto the textured surface to increase the durability of the decorative panel.

A preferred method is characterized in that the bottom surface of the decorative panel is provided by the bottom of the decorative particulate layer.

It is a benefit of such embodiments that a decorative panel is obtained comprising the same composition throughout its thickness, facilitating recycling of the decorative panels at end-of-life of the decorative panel.

A preferred method is characterized in that the first set of lignocellulosic particles and the second set of lignocellulosic particles are scattered or deposited onto a carrier board, such that the decorative particulate layer is bonded onto the carrier board.

It is a benefit of such embodiments that a decorative panel with optimized properties can be obtained. The decorative particulate layer provides the surface decoration, while the carrier board can provide other properties, e.g. enhanced mechanical performance of the decorative panel. As an example, coupling parts can be milled in the carrier board to enable coupling of the decorative panels in a covering, e.g. a floor covering or a wall covering.

The method can comprise the step of laminating the consolidated decorative particulate layer onto a carrier board. To this end, an adhesive can be applied onto the carrier board or onto the decorative particulate layer to enable the step of laminating the consolidated decorative particulate layer onto the carrier board.

The carrier board can be selected from or can comprise a wood fiber board (e.g. an MDF board—Medium Density Fiberboard—or an HDF board—High Density Fiberboard), a wood particle board or a mineral board (e.g. a cement based board, a gypsum board or a magnesium oxide board).

A third set of lignocellulosic particles can be provided in a preferred embodiment of the method of the invention. The lignocellulosic particles of the third set of lignocellulosic particles have a third color; wherein the third color differs from the first color and from the second color. The third set of lignocellulosic particles can be scattered or deposited together with or separately from the scattering or depositing of the first set of lignocellulosic particles and the second set of lignocellulosic particles.

In a preferred embodiment, in addition to a third set of lignocellulosic particles, a fourth set of lignocellulosic particles can be provided in an embodiment of the method of the invention. The lignocellulosic particles of the fourth set of lignocellulosic particles have a fourth color; wherein the third color differs from the first color, from the second color and from the third color. The fourth set of lignocellulosic particles can be scattered or deposited together with or separately from the scattering or depositing of the first set of lignocellulosic particles, the second set of lignocellulosic particles and the third set of lignocellulosic particles.

The second aspect of the invention relates to a decorative panel. The decorative panel comprises a decorative particulate layer at least 0.5 mm thick, and preferably at least 1 mm thick, and more preferably at least 3 mm thick. The decorative particulate layer provides the décor of the decorative panel; wherein the decorative particulate layer comprises a first set of lignocellulosic particles—e.g. fibers, chips, shives or flour—, and a second set of lignocellulosic particles—e.g. fibers, chips, shives or flour—; wherein the lignocellulosic particles of the first set of lignocellulosic particles have a first color; wherein the lignocellulosic particles of the second set of lignocellulosic particles have a second color. The first color differs from the second color. The first set of lignocellulosic particles and the second set of lignocellulosic particles are bonded in the decorative particular layer by means of a binder.

The decorative surface of the decorative panel can be sanded after signs of wear are visible at the surface of the decorative panel. It is a benefit that after sanding, the panel still has a decorative surface. It is possible that a lacquer layer is applied onto the decorative panel for increasing the wear resistance of the panel. After sanding after signs of wear of the decorative panel, a new lacquer layer can be applied to increase the wear resistance of the decorative panel.

Preferably, the decorative particulate layer is less than 12 mm thick, more preferably less than 10 mm thick.

A preferred decorative panel is characterized in that the lignocellulosic particles of the first set of lignocellulosic particles are selected from fibers, chips, shives or flour (e.g. wood flour), or combinations thereof. Such particles are biobased.

A preferred decorative panel is characterized in that the lignocellulosic particles of the second set of lignocellulosic particles are selected from fibers, chips, shives or flour (wood flour), or combinations thereof. Such particles are biobased.

Examples of lignocellulosic particles that can be used for the lignocellulosic particles of the first set or for the lignocellulosic particles of the second set are wood chips, plant shives (e.g. flax shives, miscanthus shives), wood fiber or other vegetal fiber, and wood flour. Such particles are biobased. Wood fibers, wood chips and wood flour can even be based on waste products and/or end-of-life wood products.

A preferred decorative panel is characterized in that the decorative particulate layer comprises color patterns provided on the one hand by the first set of lignocellulosic particles and on the other hand by the second set of lignocellulosic particles.

A preferred decorative panel is characterized in that the first set of lignocellulosic particles and the second set of lignocellulosic particles are inhomogeneously blended in the decorative particulate layer. Such decorative panels can be made in a simple way, as the formation of the decorative particulate layer in manufacturing the decorative panel does not need complex equipment for scattering two different sets of lignocellulosic particles, but the two sets can be scattered or deposited together.

A preferred decorative panel is characterized in that the binder comprises or consists of a thermoset binder or a thermoplastic binder, or a combination of a thermoset binder and a thermoplastic binder.

A preferred decorative panel is characterized in that the binder comprises a thermoset binder, wherein the thermoset binder is selected from the list of a urea formaldehyde binder, a melamine urea formaldehyde binder, a polyurethane binder, a pMDI binder, a hyperbranched polyamide, a starch based resin, a thermoset polyester, or a biobased thermoset resin.

Hyperbranched polyamides, starch based resins, or biobased thermoset resins have the benefit that they are biobased, increasing the amount of biobased raw materials used in manufacturing the decorative panel.

A preferred decorative panel is characterized in that the binder comprises a thermoplastic binder, wherein the thermoplastic binder is selected from the list of thermoplastic polyurethane (TPU), polylactic acid (PLA), polyvinyl butyral (PVB), polyhydroxyalkanoates (PHA), polyvinyl acetate (PVAc), thermoplastic acrylates, or acrylonitrile/butadiene/styrene copolymers.

A decorative panel comprising polylactic acid (PLA) or polyhydroxyalkanoates (PHA) as binder is particularly preferred, as the amount of biobased materials used is increased.

A preferred decorative panel is characterized in that the binder comprises pigments or dyes.

A binder comprising pigments or dyes has the benefit that the lignocellulosic particles of the first set of lignocellulosic particles can be provided with the first color, or the lignocellulosic particles of the second set of lignocellulosic particles can be provided with the second color, or a coloration in the mass of the decorative particulate layer can be obtained, around both sets of lignocellulosic particles.

A preferred decorative panel is characterized in that a lacquer (e.g. a varnish or a stain) is applied onto the decorative particulate layer. The application of such lacquer improves the wear resistance of the decorative panel.

Such panel has the benefit that after wear has occurred, the surface of the panel can be sanded thereby restoring the visual appearance of the original panel, and a new lacquer layer, e.g. a varnish or stain, can be applied.

The lacquer can be a transparent lacquer.

The lacquer can be a colored lacquer, e.g. a lacquer comprising pearlescent particles.

The lacquer can be a polyurethane lacquer. The lacquer can be an acrylate lacquer. The can be a radiation curable lacquer, e.g. a UV-curing lacquer, an excimer curing lacquer or an electron beam curing lacquer.

The lacquer can also be a lacquer that cures at room temperature.

A preferred decorative panel is characterized in that the lignocellulosic particles of the first set of lignocellulosic particles are dyed to obtain the first color, preferably using biobased dyes or biobased pigments.

The use of biobased dyes or biobased pigments is preferred, as it increases the amount of biobased materials used in manufacturing the decorative panel.

A preferred decorative panel is characterized in that the lignocellulosic particles of the second set of lignocellulosic particles are dyed to obtain the second color, preferably using biobased dyes or biobased pigments.

The use of biobased dyes or biobased pigments is preferred, as it increases the amount of biobased materials used in manufacturing the decorative panel.

A preferred decorative panel is characterized in that the second color is the natural color of the lignocellulosic particles of the second set of lignocellulosic particles.

It is a benefit of this embodiment that less raw material is required, and that the manufacturing of the decorative panel needs less processing steps as the lignocellulosic particles of the second set do not need to be dyed. Consequently, the manufacturing of the decorative panel as well as its disposal has less environmental impact.

A preferred decorative panel is characterized in that the first color is the natural color of the lignocellulosic particles of the first set of lignocellulosic particles; and that the second color is the natural color of the lignocellulosic particles of the second set of lignocellulosic particles. It is a benefit of this embodiment that less raw material is required, and that the manufacturing of the decorative panel needs less processing steps as the lignocellulosic particles of the first set and of the second set do not need to be dyed. Consequently, the manufacturing of the decorative panel as well as its disposal have less environmental impact.

A preferred decorative panel is characterized in that the decorative surface of the decorative particulate layer comprises a texture. More preferably, in addition to a texture, the decorative surface comprises a lacquer. It is a benefit of the lacquer that wear resistance of the decorative surface is improved.

A preferred decorative panel is characterized in that the bottom surface of the decorative panel is provided by the bottom of the decorative particulate layer.

Such decorative panels have the benefit that throughout their thickness they have the same composition, facilitating recycling of the decorative panels at their end-of-life.

A preferred decorative panel is characterized in that the decorative particulate layer is provided on—and preferably contacting—a carrier board.

It is a benefit of such embodiments that a decorative panel with optimized properties is obtained. The decorative particulate layer provides the surface decoration, while the carrier board can provide other properties, e.g. enhanced mechanical performance of the decorative panel. As an example, coupling parts can be milled in the carrier board to enable coupling of the decorative panels in a covering, e.g. a floor covering or a wall covering.

The decorative particulate layer can be adhered onto a carrier board by means of an adhesive.

The carrier board can be selected from or can comprise a wood fiber board (e.g. an MDF board—Medium Density Fiberboard—or an HDF board—High Density Fiberboard), a wood particle board or a mineral board (e.g. a cement based board, a gypsum board or a magnesium oxide board).

When the carrier board is a wood fiber board or a wood particle board, preferably the binder used in the wood fiber board or in the wood particle board is a biobased binder, e.g. a binder comprising hyperbranched polyamide. The use of biobased binders is preferred as the amount of biobased materials in the decorative panel is higher.

A preferred decorative panel is characterized in that the decorative panel is rectangular, square or oblong. The decorative panel comprises at least at two opposite side edges coupling parts for coupling the decorative panel with a second such decorative panel at their respective side edges; wherein in coupled condition a locking is provided in the direction perpendicular to the surface of the coupled decorative panels; as well as a locking is provided in the direction perpendicular to the coupled side edges and parallel with the surface of the coupled decorative panels. The coupling parts comprise at one of the two opposite side edges a male coupling part, and the coupling parts comprise at the other one of said two opposite side edges a female coupling part.

Such decorative panels have the benefit that they can be floatingly installed to a floor covering, eliminating the need to use adhesives when installing the decorative panels.

In a preferred embodiment, the male coupling part comprises a tongue; and the female coupling part comprises a groove, wherein the groove is bordered by an upper lip and by a lower lip. More preferably, the lower lip extends more distal than the upper lip.

A preferred decorative panel is characterized in that the coupling parts are configured as on the one hand a tongue and on the other hand a groove bordered by an upper lip and a lower lip; wherein the tongue and the groove provide in coupled condition a locking in the direction perpendicular to the surface of the coupled decorative panels. The tongue and the groove comprise locking parts, wherein the locking parts provide in coupled condition a locking in the direction perpendicular to the coupled side edges and parallel with the surface of the coupled decorative panels. More preferably, the locking parts comprise a protrusion at the lower lip and a corresponding recess at the bottom of the tongue.

Preferably, the coupling parts are configured such that the coupling can be performed by means of an angling movement of the respective side edges of the decorative panels to be coupled.

A preferred panel is characterized in that the decorative particulate panel layer is provided on a carrier board, wherein the coupling parts are provided in the carrier board. As the carrier board can be selected for improved mechanical performance, the milling of the coupling parts, the ease and quality of coupling and the durability of the coupling of the decorative panels is improved.

Particularly preferred lignocellulosic particles for use in the method according to the invention and in the decorative panel according to the invention are wood-based particles—e.g. wood chips, wood fibers, or wood flour—, or plant based material such as flax shives or miscanthus chips or miscanthus shives.

With the intention of better showing the characteristics of the invention, hereafter, as an example without any limitative character, several preferred embodiments are described, with reference to the accompanying drawings, wherein:

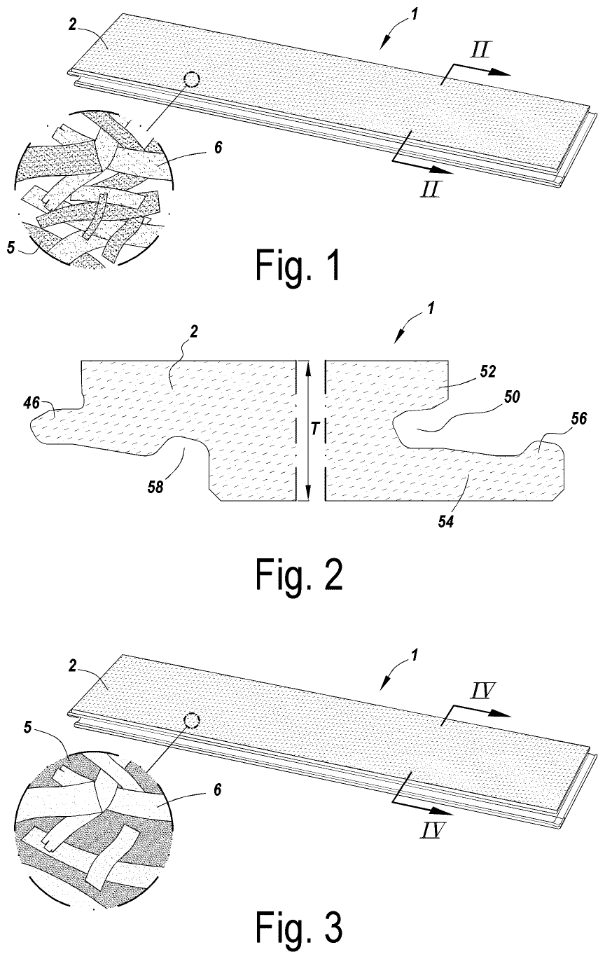

FIG. 1 shows an example of a decorative panel according to the invention;

FIG. 2 shows a cross section according to II-II of the decorative panel of FIG. 1;

FIG. 3 shows an example of a decorative panel according to the invention;

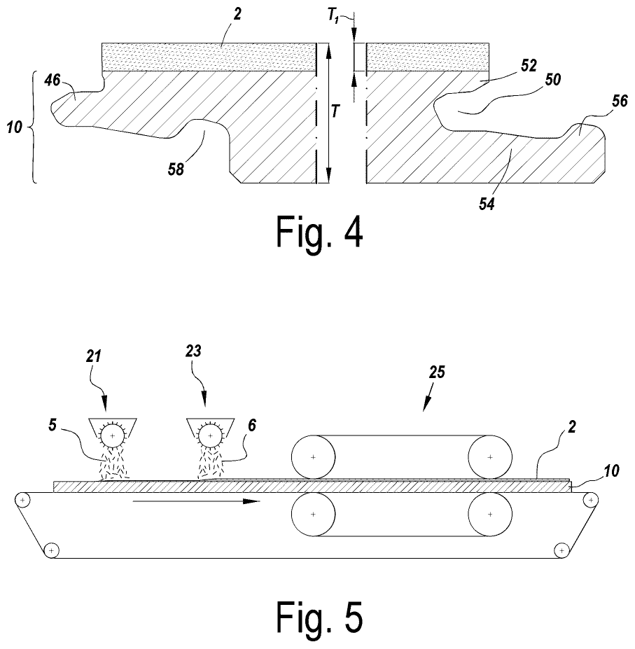

FIG. 4 shows a cross section according to II-II of FIG. 3 of a decorative panel according to the invention;

FIG. 5 illustrates a method according to the invention.

FIG. 1 shows an example of a decorative panel 1 according to the invention. The decorative panel 1 comprises a decorative particulate layer 2. The decorative particulate layer 2 provides the décor of the decorative panel. The decorative particulate layer 1 comprises a first set of lignocellulosic particles 5 and a second set of lignocellulosic particles 6. The lignocellulosic particles 5 of the first set of lignocellulosic particles and the lignocellulosic particles 6 of the second set of lignocellulosic particles are miscanthus chips. The lignocellulosic particles 5 of the first set of lignocellulosic particles have been dyed red using a biobased red dye. The lignocellulosic particles 6 of the second set of lignocellulosic particles have their natural color. The first set of lignocellulosic particles 5 and the second set of lignocellulosic particles 6 are bonded in the decorative particular layer by means of a binder.

The first set of lignocellulosic particles 5 and the second set of lignocellulosic particles 6 each provide 47.5 percent by weight of the decorative particulate layer 2. The binder provides 5 percent by weight of the decorative particulate layer 2. In the example, the binder used is a polymeric methylene diphenyl diisocyanate (pMDI).

The first set of lignocellulosic particles 5 and the second set of lignocellulosic particles 6 have been scattered such that a color pattern is obtained in the decorative particulate layer, and thus also at the surface of the decorative panel. Before scattering, the first set of cellulosic particles 5 and the second set of cellulosic particles 6 can have been coated with the binder.

Optionally, a texture can have been pressed in the decorative particulate layer, e.g. during consolidation of the decorative particulate layer using increased temperature and pressure thereby curing the binder.

Optionally, a lacquer can be applied on the surface of the decorative particulate layer.

FIG. 2 shows a cross section according to II-II of the decorative panel of FIG. 1. The reference numerals have the same meaning as in FIG. 1.

The top and bottom surface of the decorative panel 1 of FIGS. 1 and 2 is provided by the decorative particulate layer 2. The decorative panel 1 has thickness T 8 mm thick.

The decorative panel 1 comprises at opposite side edges coupling parts for coupling the decorative panel with a second such decorative panel at their respective side edges. The coupling parts comprise at one of the two opposite side edges a male coupling part comprising a tongue 46. The coupling parts comprise at the other one of the two opposite side edges a female coupling part comprising a groove 50, bordered by an upper lip 52 and by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel with the surface of the coupled layered panels. In the example shown, the locking parts 56, 58 comprise a protrusion 56 at the lower lip 54, and a corresponding recess 58 at the bottom of the tongue 46.

The coupling parts of the decorative panel of the example are configured such that the coupling can be performed by means of an angling movement of the respective side edges of the decorative panels to be coupled.

FIG. 3 shows an example of a decorative panel 1 according to the invention. The decorative panel 1 comprises a decorative particulate layer 2.

The decorative particulate layer 2 provides the décor of the decorative panel. The decorative particulate layer 2 comprises a first set of lignocellulosic particles 5 and a second set of lignocellulosic particles 6.

The lignocellulosic particles 5 of the first set consist of wood flour. This wood flour provides 41 percent by weight of the decorative particulate layer 2.

The lignocellulosic particles 6 of the second set of lignocellulosic particles are flax shives, sieved with a sieve having 8 mm mesh. The flax shive have their natural color. The flax shives provide 11 percent by weight of the decorative particulate layer 2.

The decorative particulate layer 2 comprises 41 percent by weight of a polyvinyl acetate binder, and 7 percent by weight of carbon black (as pigment), added to the binder.

The wood flour has been added to the binder; and the flax shives have been added, forming an inhomogeneous blend of wood flour and flax shives in the biner. The inhomogeneous blend of wood flour and flax shives coated with binder has been formed into panel shape and consolidated by heat and pressure to form the decorative particulate layer 2.

The binder—with the carbon black pigment in it—completely surrounds the wood flour and provides a black color to the wood flour. As the particles of wood flour are small, the visual appearance of the decorative particulate layer 2 of this example is a black surface with the flax shives embedded in it.

Optionally, a texture can have been pressed in the decorative particulate layer, e.g. during consolidation of the decorative particulate layer using increased temperature and pressure thereby curing the binder.

Optionally, a lacquer can be applied on the surface of the decorative particulate layer.

FIG. 4 shows a cross section according to II-II of the decorative panel 1 of FIG. 3. The decorative panel 1 has thickness T 10 mm. The decorative panel 1 comprises a carrier board 10 onto which the decorative particulate layer 2 is adhered. The adhesion can be provided by an additional adhesive, or by the binder of the decorative particulate layer 2. In the example shown the decorative particulate layer 2 has thickness T1 of 2 mm.

In the example shown, the carrier board 10 is an 8 mm thick High Density Fiberboard (HDF). However, other types of carrier boards can also be used in the invention.

The decorative panel 1 comprises at opposite side edges coupling parts for coupling the decorative panel with a second such decorative panel at their respective side edges. The coupling parts comprise at one of the two edges a male coupling part comprising a tongue 46. The coupling parts comprise at the other one of the two edges a female coupling part comprising a groove 50, bordered by an upper lip 52 and by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel with the surface of the coupled layered panels. In the example shown, the locking parts 56, 58 comprise a protrusion 56 at the lower lip 54, and a corresponding recess 58 at the bottom of the tongue 46.

The coupling parts of the panel of the example are configured such that the coupling can be performed by means of an angling movement of the respective side edges of the decorative panels to be coupled.

The coupling parts are provided in the carrier board 10.

FIG. 5 illustrates an example of the method according to the invention for producing a decorative panel.

A carrier board 10, e.g. a High Density Fiberboard, is provided. By means of a first scattering unit 21 a first set of lignocellulosic particles 5 is scattered onto the carrier board 10. By means of a second scattering unit 23 a second set of lignocellulosic particles 6 is scattered onto the carrier board 10.

The lignocellulosic particles of the first set of lignocellulosic particles have a first color. The lignocellulosic particles of the second set of lignocellulosic particles have a second color.

The scattering can be performed to establish color patterns in the resulting decorative particulate layer 2, e.g. a pattern as shown in the decorative particulate layer 2 of the decorative panel 1 shown in FIGS. 1 and 2.

The lignocellulosic particles of the first set and of the second set have in the example been coated by a binder, e.g. by a thermoset binder, prior to the scattering operation.

The deposited first and second set of lignocellulosic particles are consolidated in a double belt press 25 using temperature and pressure, wherein the thermoset binder cures and the lignocellulosic particles are consolidated thereby obtaining the decorative particulate layer 2. At the same time, the thermoset binder can provide adhesion between the decorative particulate layer 2 and the carrier board 10, thereby obtaining a decorative panel.

The present invention is in no way limited to the embodiments described as examples and represented in the figures, on the contrary it can be realized in various forms and variations, without leaving the scope of the invention.

1.-47. (canceled)

48. A decorative panel, wherein the decorative panel comprises a decorative particulate layer at least 0.5 mm thick;
wherein the decorative particulate layer provides the décor of the decorative panel;
wherein the decorative particulate layer comprises a first set of lignocellulosic particles, and a second set of lignocellulosic particles;
wherein the lignocellulosic particles of the first set of lignocellulosic particles have a first color;
wherein the lignocellulosic particles of the second set of lignocellulosic particles have a second color;
wherein the first color differs from the second color;
wherein the first set of lignocellulosic particles and the second set of lignocellulosic particles are bonded in the decorative particular layer by means of a binder.

49. The decorative panel as in claim 48, wherein the lignocellulosic particles of the first set of particles are selected from fibers, chips, shives or flour; and
wherein the lignocellulosic particles of the second set of particles are selected from fibers, chips, shives or flour.

50. The decorative panel as in claim 48, wherein the decorative particulate layer comprises color patterns provided on the one hand by the first set of lignocellulosic particles and on the other hand by the second set of lignocellulosic particles.

51. The decorative panel as in claim 48, wherein the first set of lignocellulosic particles and the second set of lignocellulosic particles are inhomogeneously blended in the decorative particulate layer.

52. The decorative panel as in claim 48, wherein the binder comprises or consists of a thermoset binder or a thermoplastic binder, or a combination of a thermoset binder and a thermoplastic binder.

53. The decorative panel as in claim 48, wherein the binder comprises a thermoset binder,
wherein the thermoset binder is selected from the list of a urea formaldehyde binder, a melamine urea formaldehyde binder, a polyurethane binder, a pMDI binder, a hyperbranched polyamide, a starch based resin, a thermoset polyester, or a biobased thermoset resin.

54. The decorative panel as in claim 48, wherein the binder comprises a thermoplastic binder,
wherein the thermoplastic binder is selected from the list of thermoplastic polyurethane (TPU), poly lactic acid (PLA), polyvinyl butyral (PVB), polyhydroxyalkanoate (PHA), polyvinyl acetate (PVAc), thermoplastic acrylates, or acrylonitrile/butadiene/styrene copolymers.

55. The decorative panel as in claim 48, wherein the binder comprises pigments or dyes.

56. The decorative panel as in claim 48, wherein a lacquer is provided onto the decorative particulate layer.

57. The decorative panel as in claim 48, wherein the lignocellulosic particles of the first set of lignocellulosic particles are dyed to obtain the first color; and/or
wherein the lignocellulosic particles of the second set of lignocellulosic particles are dyed to obtain the second color.

58. The decorative panel as in claim 48, wherein the second color is the natural color of the lignocellulosic particles of the second set of lignocellulosic particles.

59. The decorative panel as in claim 48, wherein the first color is the natural color of the lignocellulosic particles of the first set of lignocellulosic particles; and that the second color is the natural color of the lignocellulosic particles of the second set of lignocellulosic particles.

60. The decorative panel as in claim 48, wherein the decorative surface of the decorative particulate layer comprises a texture.

61. The decorative panel as in claim 48, wherein the bottom surface of the decorative panel is provided by the bottom of the decorative particulate layer.

62. The decorative panel as in claim 48, wherein the decorative particulate layer is provided on a carrier board.

63. The decorative panel as in claim 62, wherein the decorative particulate layer is adhered onto the carrier board by means of an adhesive.

64. The decorative panel as in claim 62, wherein the carrier board is selected from or comprises a wood fiber board, a wood particle board or a mineral board.

65. The decorative panel as in claim 48, wherein the decorative panel is rectangular, square or oblong,
wherein the decorative panel comprises at least at two opposite side edges coupling parts for coupling the decorative panel with a second such decorative panel at their respective side edges;
wherein in coupled condition a locking is provided in the direction perpendicular to the surface of the coupled decorative panels; as well as a locking is provided in the direction perpendicular to the coupled side edges and parallel with the surface of the coupled decorative panels;
wherein the coupling parts comprise at one of said two opposite side edges a male coupling part;
wherein the coupling parts comprise at the other one of said two opposite side edges a female coupling part.
